(19) United States
(12) Patent Application Publication
(10) Pub. No.: US 2023/0217847 A1
(43) Pub. Date: Jul. 13, 2023

(54) ROD WEEDER HAVING QUICK-CHANGE ROD FUNCTIONALITY

(71) Applicant: Tyler Remoue, Rockglen (CA)

(72) Inventor: Tyler Remoue, Rockglen (CA)

(21) Appl. No.: 17/916,123

(22) PCT Filed: Apr. 16, 2021
(86) PCT No.: PCT/CA2021/050510

§ 371 Date: Sep. 30, 2022

(30) Foreign Application Priority Data
Mar. 30, 2020 (CA) 3077437

(51) Int. Cl. A01B 39/19; A01B 63/10; A01B 49/02

(52) U.S. Cl. CPC A01B 39/19; A01B 63/10; A01B 49/022

(57) ABSTRACT

A rod weeder wherein the rotatable rod is provided as a quick-change rod assembly comprising the rod and rod shoes for being mounted to the rod shanks resulting in the ability to quickly release and change the quick-change rod assembly from the tool frame and the remainder of the implement. Optionally, the rod weeder may comprise disk openers placed in proximity to the gauge wheels, or the support beam may be pivotally movable mounted to the connecting structure such that the same is enabled to oscillate about an axis through a centre pivot and oriented parallel to a forward moving direction of the rod weeder.

### FIELD OF THE INVENTION

The present invention relates to agricultural implements, and more particularly to a rod weeder that has quick-change rod functionality and, optionally, further improved operational functionalities.

### BACKGROUND OF THE INVENTION

Rod weeders are well known and used in large numbers for weed control. Typically, a rod weeder drags a rod oriented substantially perpendicular to a moving direction of the rod weeder through the soil just below the soil surface. The rod is driven by a suitable drive mechanism such that it rotates about a longitudinal axis thereof at a rate of approximately 100 to 150 rpm in an opposite direction to a rolling direction associated with the moving direction of the rod weeder. The rotating rod cuts and/or pulls weeds and lifts the same to the soil surface where they wither and die. Furthermore, the rotating rod packs the soil below the rod to create a firm moist seed bed and above the rod, the soil is aerated to dry hence, prohibits weeds from growing.

Present-day rod weeders have a number of significant disadvantages. Firstly, as the level of the ground varies, the depth of the rod relative to the soil surface varies. For example, while one portion of the rod is placed too deep into the soil another portion may be placed above the soil surface, substantially reducing the effectiveness of the rod weeder. Secondly, the down-pressure exerted onto the rod is not adjustable, resulting in the rod being placed too deep in light soil or not deep enough in heavy soil. Thirdly, replacement of the rod when damaged, for example, after encountering rocks or other debris, is difficult and can likely only be done in a workshop. Fourthly, plant debris disposed on the soil surface, for example, plant debris left after a previous harvest to prevent soil erosion or to keep moisture in the soil, can get caught at or between the shanks holding the gauge wheels and the shanks holding the rod.

It is desirable to provide a rod weeder that enables simple replacement of the rod.

It is also desirable to provide a rod weeder that is capable of preventing debris disposed on the soil surface from getting caught.

It is also desirable to provide a rod weeder that enables the rod to follow the level of the ground.

It is also desirable to provide a rod weeder that is capable of providing an adjustable down-pressure exerted onto the rod.

### SUMMARY OF THE INVENTION

Accordingly, one object of the present invention is to provide a rod weeder that enables simple replacement of the rod.

Another object of the present invention is to provide a rod weeder that is capable of preventing debris disposed on the soil surface from getting caught.

Accordingly, one object of the present invention is to provide a rod weeder that enables the rod to follow the level of the ground.

Another object of the present invention is to provide a rod weeder that is capable of providing an adjustable down-pressure exerted onto the rod.

According to one aspect of the present invention, there is provided a rod weeder. The rod weeder comprises a mounting structure adapted for being mounted to a tractor or larger farm implement. A support frame is pivotally movable mounted to the mounting structure at a first end thereof. A connecting structure is mounted to a second end of the support frame. A support beam is mounted to the connecting structure. The support beam has a plurality of rod shanks extending downwardly therefrom.

A releasable quick-change rod assembly is mounted to the rod shanks. The quick-change rod assembly comprises rod shoes corresponding to each rod shank which permit for the releasable attachment of the rod shoot to the rod shank the assembly also comprises a rod extending and engaged rotatably through the rod shoes and connected to a drive means for axial rotation of the rod in operation of the rod weeder. A hydraulic cylinder moves the rod weeder between a raised position and an operating position and for providing down-pressure during operation. The unitary quick-change rod assembly can be mounted to or removed from the rod shanks without the use of tools, resulting in the ability to rapidly replace the rod assembly with minimal downtime and labour requirements.

The drive means comprises of rotary power source, which could be either a powered item, or even a passive rotational source which is simply rotated by virtue of ground travel of the implement or the like. The rotary power source is connected to the rod via a rotational translation element, which comprises a chain, a V-belt or a toothed belt. The drive means is adapted to enable installation and removal of the one of a chain, a V-belt, and a toothed belt without breaking the same.

In some embodiments of the invention, the rotary power source will comprise a spring-loaded or mechanical toggle lock wheel, adapted to enable installation and removal of the rotational translation element (chain or belt) absent breaking the same. The spring loaded or mechanical toggle lock wheel is movable between an operating position and a replacement position for enabling replacement of the one of a chain, a V-belt, and a toothed belt. A holding element is adapted for holding the spring loaded wheel in the replacement position.

As outlined, is explicitly contemplated that the quick-change rod assembly would be removable from the remainder of the rod weeder with little need for tools or labour. Specifically, in many embodiments, the rod shoes and a bottom portion of the rod shanks are adapted for securing each of the rod shoes to the respective rod shank via a removable securing pin. Each rod shoe comprises two securing elements and each bottom portion of the rod shanks comprises two respective interacting elements such that the rod shoe is secured to the rod shank in a three-point manner in concert with the securing pin.

In addition to the rod weeder of the present invention including the quick-change rod assembly, the invention also is explicitly intended to encompass the quick-change rod assembly itself manufactured for use as a replacement part in accordance with the remainder of the rod weeder of the present invention. Manufacture of a quick change rod assembly comprising a rod rotatably attached to a plurality of rod shoes for engaging a corresponding plurality of rod shanks in accordance with the remainder of the rod weeder of the present invention will be understood to those skilled in the art and is intended to be encompassed within the scope hereof.

According to another aspect of the present invention, there is provided a rod weeder. The rod weeder comprises a mounting structure adapted for being mounted to a tractor or larger farm implement. A support frame is pivotally movable mounted to the mounting structure at a first end thereof. A connecting structure is mounted to a second end of the support frame. A support beam is mounted to the connecting structure. The support beam has a rod and drive means mounted thereto. Gauge wheels are mounted to respective wheel shanks extending downwardly from a first and second end portion of the support beam such that the gauge wheels are placed ahead of the rod in the forward moving direction. Disc openers are placed in proximity to the gauge wheels such that a front end thereof is placed ahead of the gauge wheels in the forward moving direction. A hydraulic cylinder moves the rod weeder between a raised position and an operating position and for providing down-pressure during operation.

The advantage of the present invention is that it provides a rod weeder that enables simple replacement of the rod.

A further advantage of the present invention is that it provides a rod weeder that is capable of preventing debris disposed on the soil surface from getting caught.

The advantage of the present invention is that it provides a rod weeder that enables the rod to follow the level of the ground.

A further advantage of the present invention is that it provides a rod weeder that is capable of providing an adjustable down-pressure exerted onto the rod.

### BRIEF DESCRIPTION OF THE DRAWINGS

A preferred embodiment of the present invention is described below with reference to the accompanying drawings, in which:

FIGS. 1a and 1b are simplified block diagrams illustrating in a front perspective view, and a side view, respectively, a rod weeder according to a preferred embodiment of the invention;

FIG. 1c is a simplified block diagram illustrating in a side view the rod weeder according to a preferred embodiment of the invention with the rod being lifted over an obstruction;

FIG. 1d is a simplified block diagram illustrating in a perspective view removal of a chain cover of the rod weeder according to the preferred embodiment of the invention;

FIG. 1e and if are simplified block diagram illustrating in a detailed side view and opposite side view, respectively, loosening of the drive chain of the rod weeder according to the preferred embodiment of the invention;

FIG. 1g is a simplified block diagram illustrating in a perspective view removal of pins securing the quick-change rod assembly of the rod weeder according to the preferred embodiment of the invention;

FIG. 1h is a simplified block diagram illustrating in a perspective view removal of the quick-change rod assembly of the rod weeder according to the preferred embodiment of the invention;

FIG. 1i is a simplified block diagram illustrating in a detailed side view removal of the quick-change rod assembly of the rod weeder according to the preferred embodiment of the invention;

FIGS. 2a to 2d are simplified block diagrams illustrating in a detailed top view, a detailed bottom view, a detailed front view, and a side view, respectively, a gauge wheel and disc opener arrangement of the rod weeder according to the preferred embodiment of the invention;

FIG. 2e is a simplified block diagram illustrating in a detailed side view adjustment of the gauge wheel and the disc opener of the rod weeder according to the preferred embodiment of the invention;

FIGS. 2f and 2g are simplified block diagrams illustrating in a detailed side view and a perspective view, respectively, a rod depth adjusting mechanism of the rod weeder according to the preferred embodiment of the invention;

FIGS. 2h and 2i are simplified block diagrams illustrating in detailed perspective side views a disc opener depth adjusting mechanism of the rod weeder according to the preferred embodiment of the invention;

FIGS. 3a and 3b are simplified block diagrams illustrating in rear views the rod weeder according to the preferred embodiment of the invention with the rod weeder being in a level and an oscillated position, respectively;

FIGS. 4a to 4c are simplified block diagrams illustrating in side views the rod weeder according to the preferred embodiment of the invention with the rod weeder being in a high down-pressure, low down-pressure, and raised position, respectively;

FIG. 4d is a simplified block diagram illustrating in a side view a down-pressure adjusting mechanism of the rod weeder according to the preferred embodiment of the invention; and

FIG. 5 is a simplified block diagram illustrating in a top view a section of a multi rod rod weeder farm implement employing a plurality of the rod weeder according to the preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a rod weeder as a single unit, it will become evident to those skilled in the art that the embodiments of the invention are not limited thereto, but are also adaptable for employing a plurality of the same in a large farm implement.

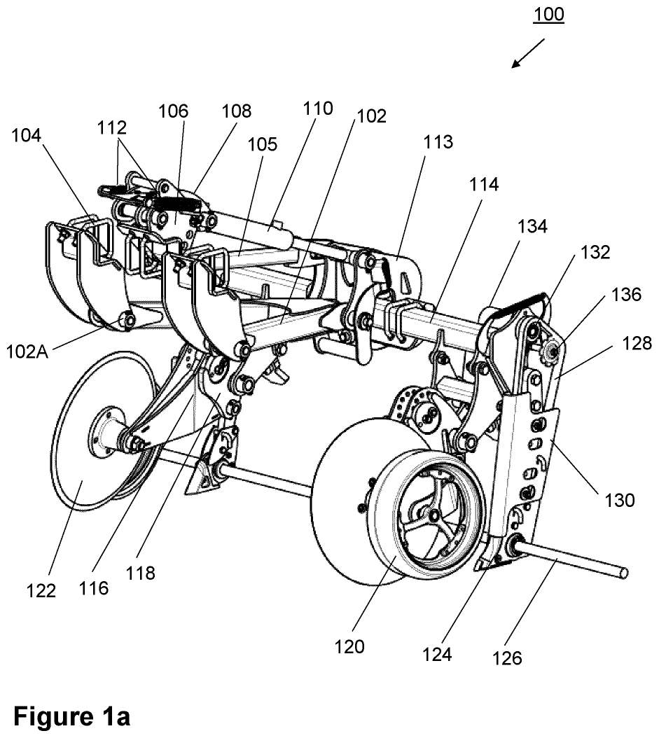

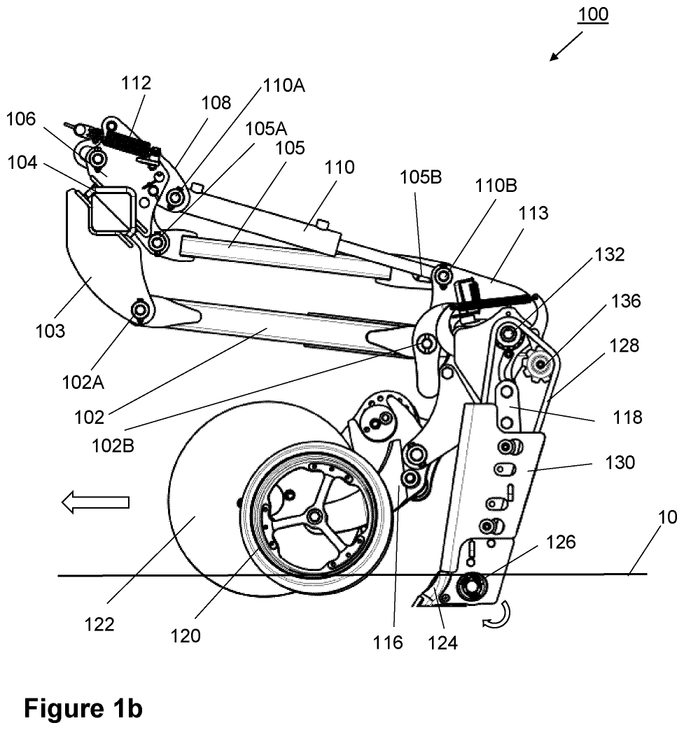

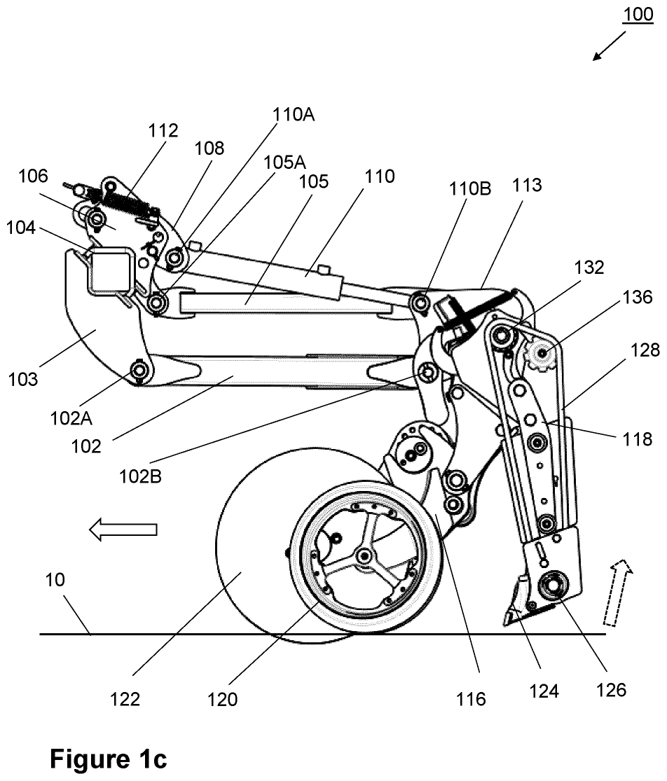

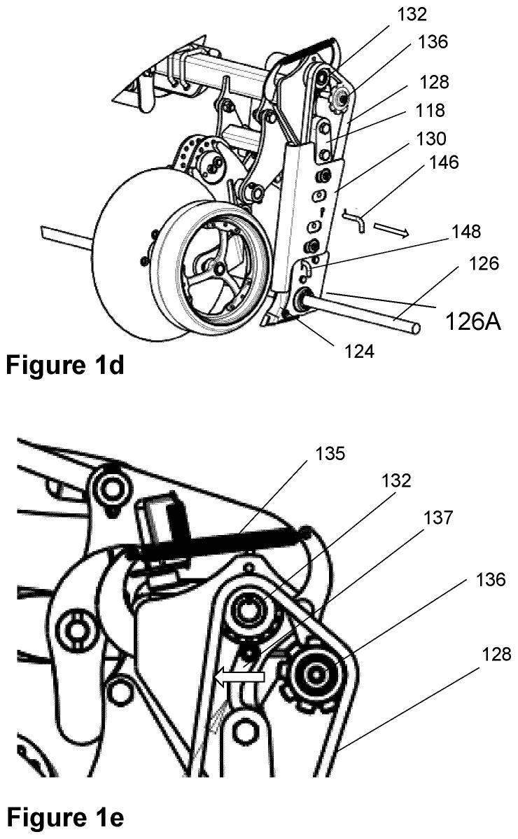

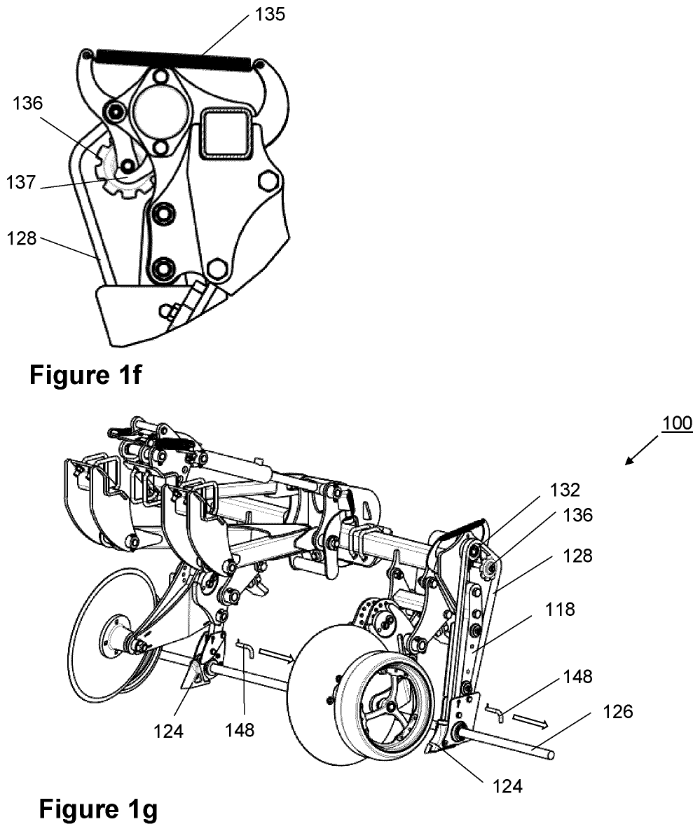

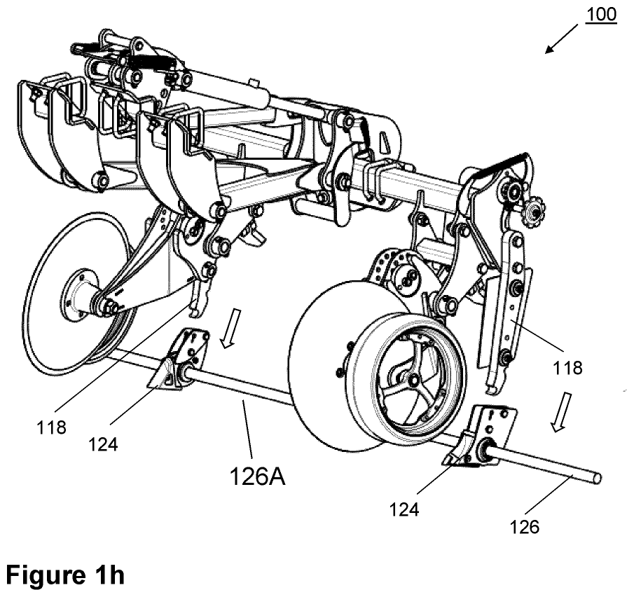

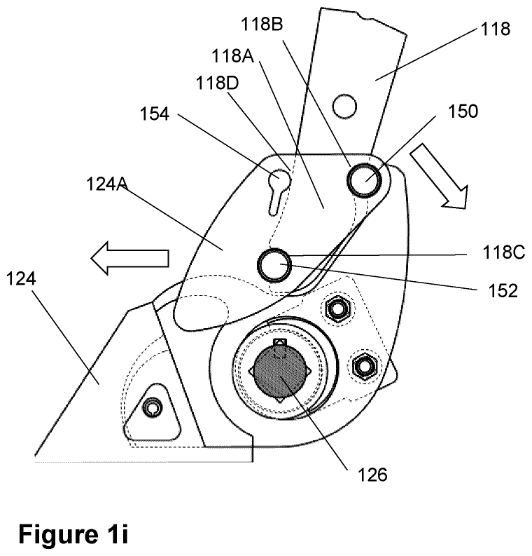

Referring to FIGS. 1a to 1i, 2a to 2e, 3a and 3b, and 4a to 4d a rod weeder 100 according to a preferred embodiment of the invention is provided. The rod weeder 100 comprises mounting structure 103, 106 which is adapted for being mounted to, for example, a tractor or a frame of a larger farm implement, via mounting elements 104. Support frame 102 is pivotally movable mounted to the mounting structure 103, 106 via pivots 102A at a first end thereof. A second end of the support frame 102 is pivotally movable mounted at pivot 102B to connecting structure 113. The support frame 102 is, for example, V-shaped, mounted at two pivots 102A to mounting structure 103 and narrowing towards the pivot 102B. The connecting structure 113 has support beam 114 mounted thereto, preferably, such that the support beam is oriented substantially perpendicular to a forward moving direction of the rod weeder 100.

The rod 126 is mounted to the support beam 114 via a quick change rod assembly comprising the rod 126 and a plurality of rod shoes 124 through which the rod 126 is rotatably engaged. The rod shoes 124 will be attached to the distal ends of the rod shanks 118 extending downwardly from a first end and a second end of the support beam 114. There are a plurality of shanks 118, namely at least two of them at each end of the support being 114 or more if the support 114 is longer and mid-rod support is desired. The rod 126 as further described below is rotatably powered by a drive means, such as a drive wheel 132 or the like connected to the rod via a rotational translation element 128 such as a chain or belt.

The rod 126 is rotatably mounted to the rod shanks 118 by the shoes 124 and driven by drive wheel 132 via chain or belt 128. The drive wheel 132 is actuated using drive 134, for example, a hydraulic motor connected to the hydraulic system of the tractor. In operation, the rod is rotating at a rate of approximately 100 to 150 rpm in an opposite direction to a rolling direction associated with the forward moving direction of the rod weeder 100, as indicated by the block arrows in FIG. 1b. Further preferably, gauge wheels 120 are mounted to respective wheel shanks 116 extending downwardly from a first and a second end portion of the support beam 114 in close proximity to the rod shanks 118 such that the gauge wheels 120 are placed ahead of the rod 126 in the forward moving direction.

Down-pressure is exerted onto the rod 126 using hydraulic cylinder 110, which is pivotally movable mounted at pivot 110A to the mounting structure 106, preferably, via head bracket 108, as will be described hereinbelow, and at pivot 110B to the connecting structure 113, such that the rod 126 is placed just below the soil surface 10, as illustrated in FIG. 1b. Guide bar 105 is pivotally movable mounted to the mounting structure 106 at pivot 105A and via slot 105B to the connecting structure 113. The slot 105B enables longitudinal movement of a connecting pin mounted to the connecting structure 113 therein between a first position at a first end thereof when the rod weeder 100 is in an operating position and second position at a second end thereof when the rod weeder 100 is in a raised position. Furthermore, the hydraulic cylinder 110 also applies trip pressure when an obstruction is encountered. The rod 126 pivots about pivot 102B and gauge wheels 120, lifting the rod 126, from the position illustrated in FIG. 1b, over the obstruction, as indicated by the dashed block arrow in FIG. 1c.

The components of the rod weeder 100 are made of, for example, steel and assembled using conventional fastening techniques such as screw fastening and/or welding. Pivotal/rotating movement is enabled using, for example, bolts disposed in respective bores or suitable bearings. The rod 126 is driven using, for example, a chain drive and sprocket wheels. Alternatively, a belt drive such as, for example, a V-belt or toothed belt, may be employed instead of a chain. The drive 134 and the hydraulic cylinder 110 are, for example, hydraulically connected to the hydraulic system of the tractor and operation thereof is remotely controlled via a control center placed at the tractor.

Preferably, the rod weeder 100 is adapted to enable easy and fast replacement of the rod 126 without use of tools. This is achieved by virtue of the use of a quick change rod assembly comprising the rod 126 and the plurality rod shoes 124 each of which is connectable to a corresponding rod shanks 118 via a connector pin or other similar and simple attachment means.

In replacement of the quick change rod assembly of the embodiment shown the chain cover 130 is removed from rod shank 118 by removing pin 146, as indicated by the block arrow in FIG. 1d. Second, the chain 128 is loosened by pushing spring loaded sprocket wheel 136 from the operating position into a replacement position, as indicated by the block arrow in FIG. 1e. The sprocket wheel 136 is secured in the replacement position using hook 137, as illustrated in FIG. 1f. Third, after loosening the chain 128, pins 148, securing rod shoes 124 to the respective rod shanks 118, are removed, as indicated by the block arrows in FIG. 1g. Fourth, after removal of the pins 148, the chain 128 is removed from the sprocket wheel 136 and the drive wheel 132 without breaking the same and, fifth, the rod shoes 124 are removed from the respective rod shanks 118, as illustrated in FIG. 1h, resulting in the removal of a quick-change rod assembly comprising the rod 126, the rod shoes 124 and the chain 128 (not shown).

In order to enable simple removal of the rod shoes 124 from the respective rod shanks 118, thus releasing the quick change rod assembly 126A, the bottom portion 118A of each of the rod shanks, preferably, comprises interacting elements 118B and 118C which are adapted to accommodate respective securing elements 150 and 152 such as, for example, pins or bolts, of the rod shoes 124, as indicated in FIG. 1i. With the pin 148 disposed in opening 154 of the rod shoe 124 and, therefore, in contact with interacting surface 118D of the bottom portion 118A of the rod shank 118, and the securing elements 150 and 152 of the rod shoes 124 in contact with the interacting elements 118B and 118C, each rod shoe 124 is securely mounted to the respective rod shank 118 in a three point manner. Removal of the pin 148 allows movement of the rod shoe 124 by slightly rotating the same about securing element 152 until the securing element 150 is removed from the interacting element 118B of the rod shank 118, followed by movement of the bolt 152 from the interacting element 118B, as indicated by the block arrows in FIG. 1i.

In certain cases the quick change rod assembly 126A comprises the rod shoes 124 and the rod 126 rotationally disposed therein. In other embodiments, the quick change rod assembly 126A would also include the rotational translation element 128. The replacement quick-change rod assembly 126A comprising the rod 126, the rod shoes 124 and the chain 128 is simply installed by performing the same steps of the above process in reverse.

Provision of the quick-change rod assembly 126A comprising the rod 126, the rod shoes 124 and the chain 128, as described hereinabove, enables a rapid change of the rod 126 without requiring any tools by simply removing pins 146 and 148, removing the used quick-change rod assembly, attaching the replacement quick-change rod assembly, and inserting the pins 146 and 148.

In addition to the rod weeder of the present invention including the quick-change rod assembly, the invention also is explicitly intended to encompass the quick-change rod assembly itself manufactured for use as a replacement part in accordance with the remainder of the rod weeder of the present invention. Manufacture of a quick change rod assembly comprising a rod rotatably attached to a plurality of rod shoes for engaging a corresponding plurality of rod shanks in accordance with the remainder of the rod weeder of the present invention will be understood to those skilled in the art and is intended to be encompassed within the scope hereof.

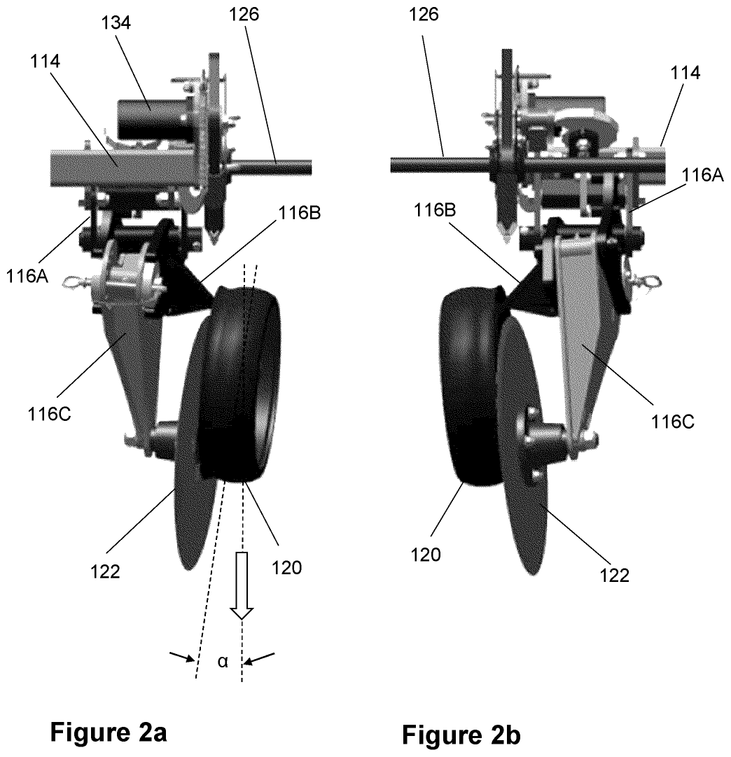

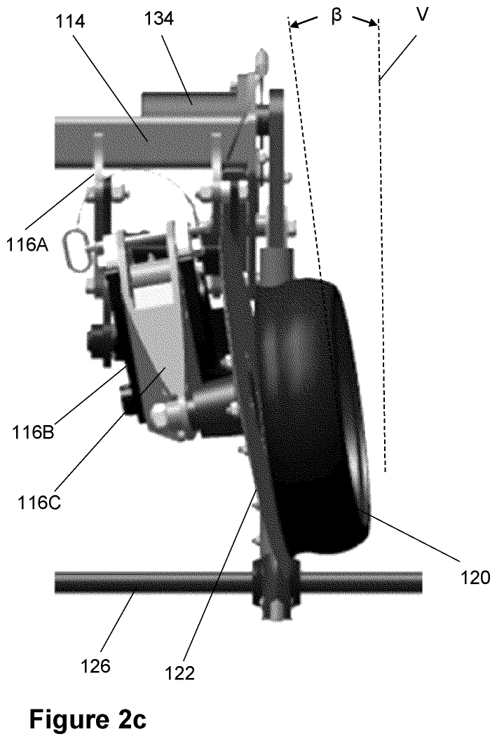

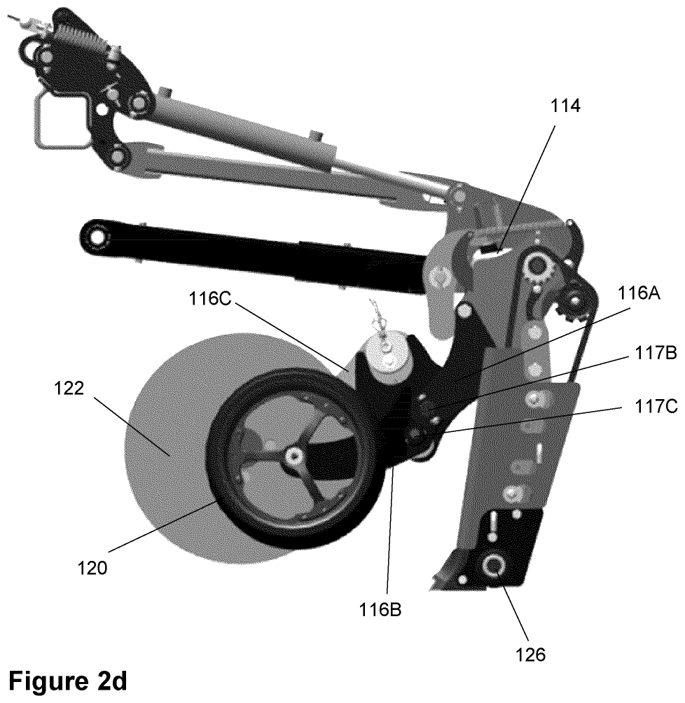

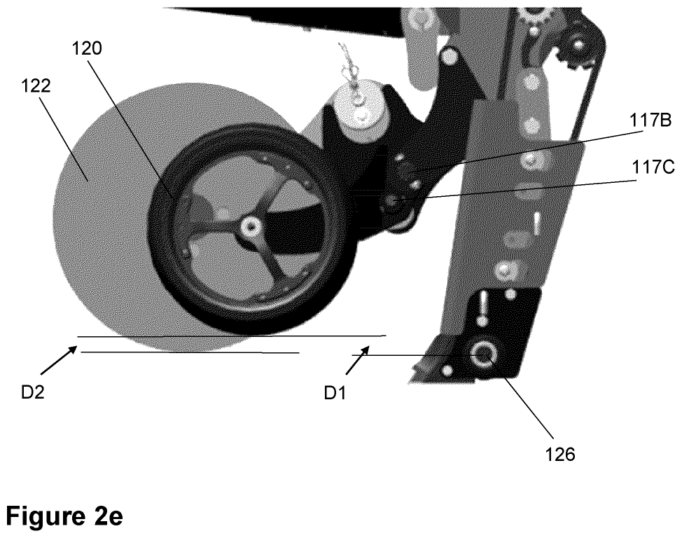

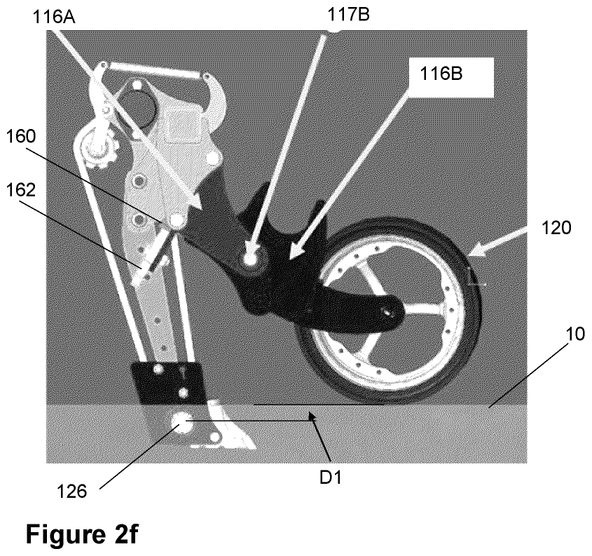

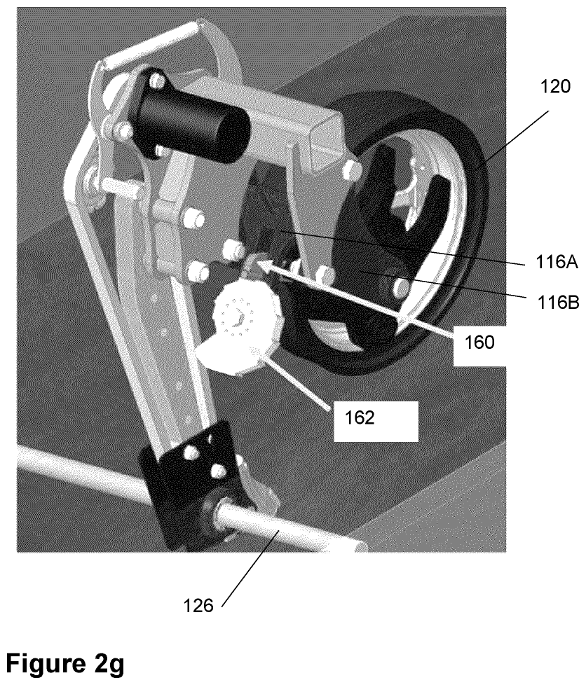

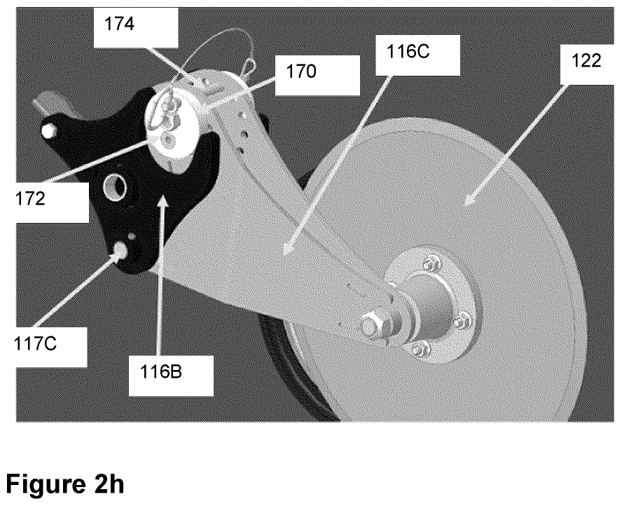

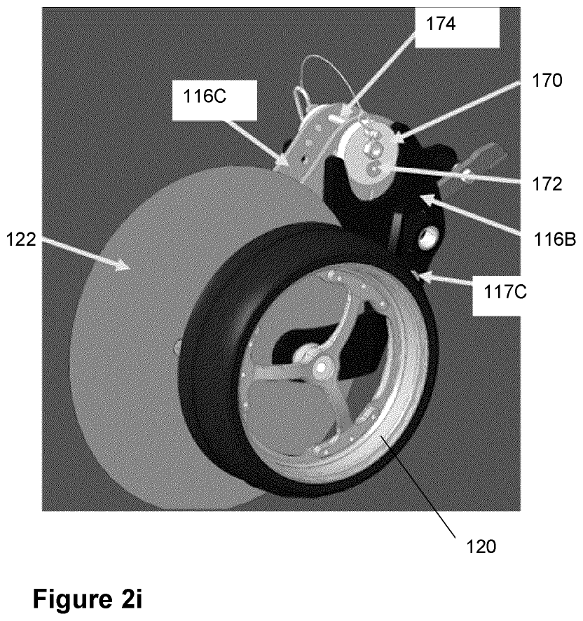

Further preferably, the rod weeder 100 comprises disk openers 122 rotatably mounted to the wheel shanks 116 in proximity to the gauge wheels 120 such that a front end thereof is placed ahead of the gauge wheels 120 in the forward moving direction and oriented substantially parallel thereto. The disk openers 122 prevent plant debris from being caught at the wheel shanks 116 or the rod shanks 118 by cutting the same or pushing them downward onto or into the soil. The disk openers 122 are made of, for example, steel and mounted to the wheel shanks 116. Further preferably, each of the wheel shanks 116 comprises three wheel shank portions 116A, 116B, and 116C, as illustrated in FIGS. 2a to 2e. The first wheel shank portion 116A is mounted to the support beam 114. The second wheel shank portion 116B, having the gauge wheel 120 rotatable movable mounted thereto, is pivotally movable mounted to the first wheel shank portion 116A at pivot 117B. The third wheel shank portion 116C, having the disc opener 122 rotatable movable mounted thereto, is pivotally movable mounted to the second wheel shank portion 116B at pivot 117C. Employment of conventional adjusting mechanisms for adjustably rotating the second wheel shank portion 116B about the pivot 117B and for adjustably rotating the third wheel shank portion 116C about the pivot 117C enables simple adjustment of the depth of the rod 126 in the ground 10 by varying the distance D1 between the bottom of the gauge wheel 120 and the rod 126, as well as the depth of the disc opener 122 into the ground 10 by varying the distance D2 between the bottom of the gauge wheel 120 and the bottom of the disc opener 122, as illustrated in FIG. 2e.

In an example implementation the wheel shank portions 116A, 116B, and 116C have been adapted such that the gauge wheel 120 and the disc opener 122 are oriented parallel to each other and oriented forwardly inwardly at an angle α of approximately 5°, as illustrated in FIG. 2a, as well as upwardly inwardly at an angle β of approximately 10° to the vertical V, as illustrated in FIG. 2c.

In the example implementation the depth D1, i.e. the depth of the rod in the ground 10 is adjusted as illustrated in FIGS. 2f and 2g. The gauge wheel 120, which is connected to the second wheel shank portion 116B and pivots about the pivot 117B, follows the contour of the ground 10. Depth adjusting element 160 is mounted to the second wheel shank portion 116B. When the rod 126 is raised from the ground 10, the depth adjusting element 160 moves upward until it is in contact with the first wheel shank portion 116A. When the rod 126 is lowered into the field position, the depth adjusting element 160 moves downward until it is in contact with depth adjusting cam 162 rotatably mounted to the first wheel shank portion 116A. By rotatably adjusting the depth adjusting cam 162 clockwise to allow the depth adjusting element 160 to travel further until it is in contact with the depth adjusting cam 162, the depth D1 increases, i.e. the rod 126 penetrates deeper into the ground 10.

The depth of the disc opener 122 into the ground 10, i.e. the depth D2 between the bottom of the gauge wheel 120 and the bottom of the disc opener 122, is adjusted as illustrated in FIGS. 2h and 2i. The disc opener 122 is connected to the third wheel shank portion 116C which is rotatable about the pivot 117C. To adjust the depth of the disc opener 122 into the ground 10, a wrench/spanner is placed on the nut welded to disc opener adjustment cam 164. Both left and right disc opener adjustment cams 164 are synchronized via the flat on cam pin 166. The disc opener adjustment cam 164 is confined by the profile of the second wheel shank portion 116B. The disc opener adjustment cam 164 is rotated to the desired depth then locked into position by securing pin 168.

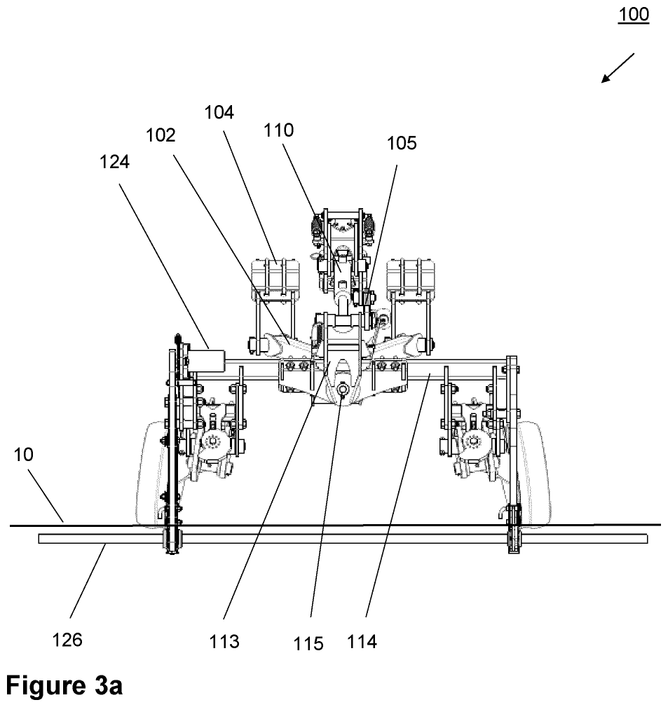

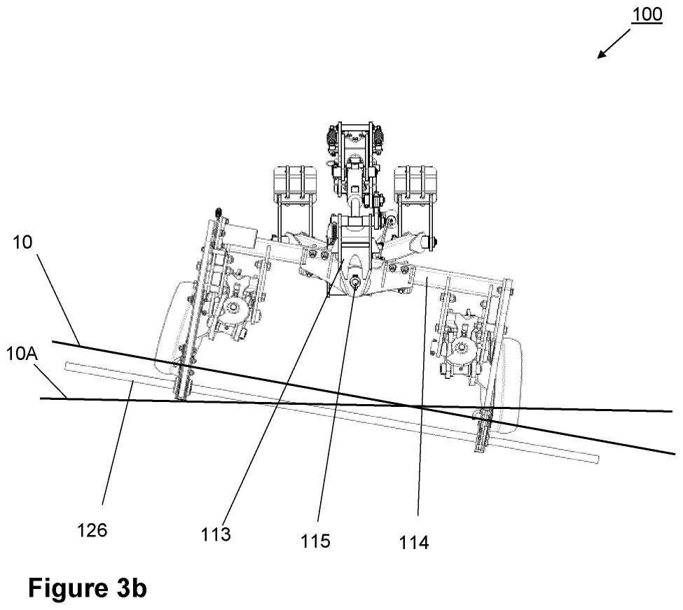

Optionally, the support beam 114 is pivotally movable mounted to the connecting structure 113 at pivot 115 such that the support beam 114 is enabled to oscillate about an axis through the pivot 115 and oriented parallel to the forward moving direction of the rod weeder. The oscillating movement of the support beam about the pivot 115 enables the rod 126 to follow the level of the ground 10 in case the same is uneven instead of level 10A, as illustrated in FIGS. 3a and 3b, thus substantially increasing the effectiveness of the rod weeder 100 when used on uneven ground.

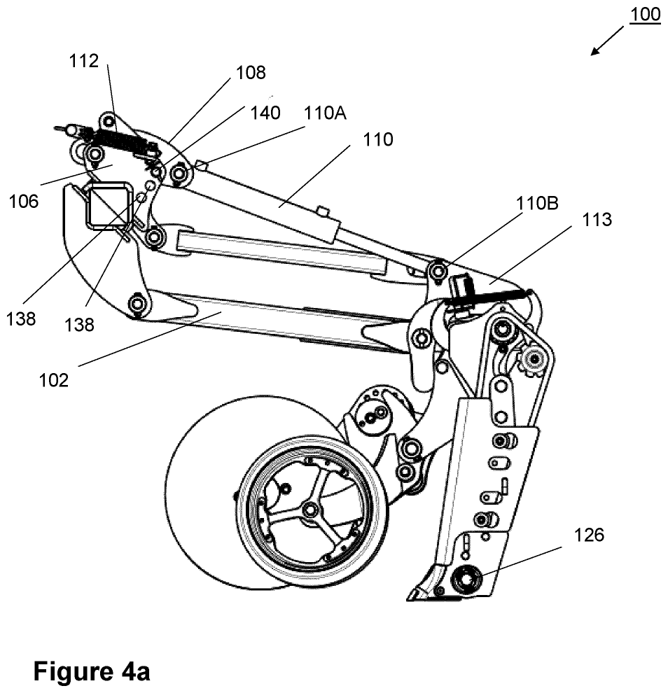

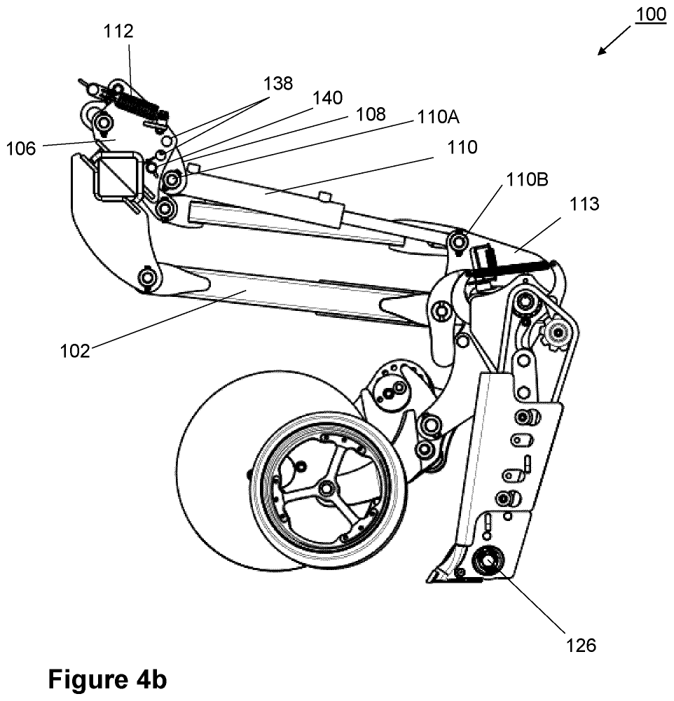

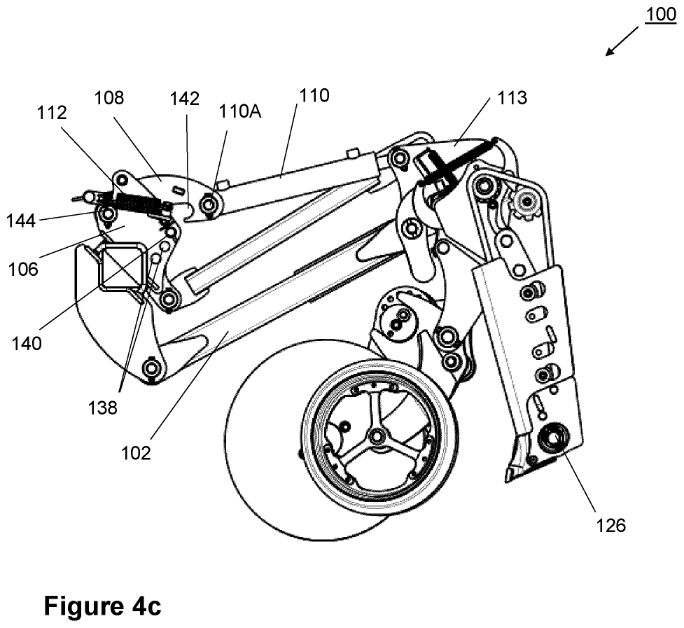

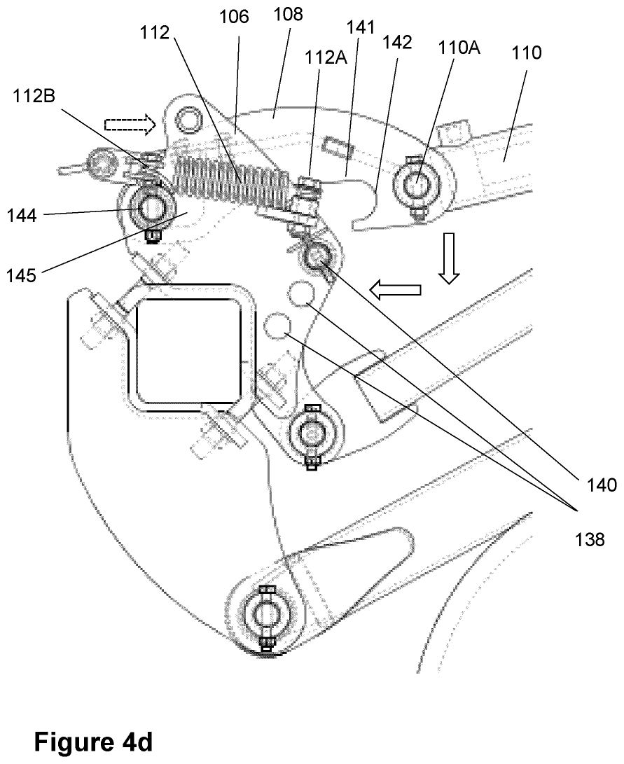

Further optionally, the rod weeder 100 is adapted to enable adjustment of the down-pressure exerted by the hydraulic cylinder 110 onto the rod 126. The down-pressure is adjusted by changing the location of the pivot 110A of the hydraulic cylinder 110 in the operating or field position, i.e. the orientation of the hydraulic cylinder 110, as illustrated in FIGS. 4a and 4b for exerting high down-pressure and low down-pressure, respectively. The down-pressure is easily adjusted by placing pin 140 into one of bores 138 disposed in the mounting structure 106 when the hydraulic cylinder 110 is in tension mode in the raised position of the rod weeder 100, as illustrated in FIG. 4c. For example, the highest possible down-pressure is selected by placing the pin 140 into the top bore 138, as illustrated in FIG. 4c, while selection of the lowest possible down-pressure is by placing the pin 140 into the bottom bore 138. As is evident to one skilled in the art, the invention is not limited to three different down-pressures as illustrated in FIGS. 4a to 4c, but may be adapted to providing a larger selection by providing more than three bores 138.

The adjustment is enabled by interposing the head bracket 108 between the mounting structure 106 and the pivot 110A of the hydraulic cylinder 110, as illustrated in FIG. 4d. The head bracket 108 is pivotally movable mounted to the mounting structure 106 at pivot 144 via slot 145 disposed therein to enable sliding movement of the head bracket 108 with respect to the mounting structure 106 as well as rotating movement. Tension spring 112 mounted to the mounting structure 106 at 112A and to the head bracket 108 at 112B exerts force onto the head bracket 108 as indicated by the dashed block arrow in FIG. 4d. When the hydraulic cylinder 110 is actuated to move the rod weeder 100 from the raised position into the operating or field position the same exerts pressure acting onto the pivots 110A and 110B. The acting pressure rotates the head bracket 108 about the pivot 144, as indicated by the downward pointing block arrow in FIG. 4d, while sliding movement of the head bracket 108 is prevented by the force exerted thereon by the spring 112. The rotation of the head bracket 108 continues until interacting surface 141 of the head bracket 108 is in contact with the pin 140 disposed in one of the bores 138, thus abutting further rotational movement of the head bracket 108. Further pressure exerted by the hydraulic cylinder 110 results in sliding movement of the head bracket 108 with respect to the mounting structure 106 until the interacting element 142 of the head bracket 108 is in contact with the pin 140, as indicated by the bloc arrow pointing towards the mounting structure 106, thus securing the head bracket 108 and pivot 110A of the hydraulic cylinder 110 in a fixed position with respect to the mounting structure 106 while in the field position.

It is noted that, while the preferred embodiment of the rod weeder 100 comprises the features of: the easily removable quick-change rod assembly; the disc openers; the oscillation about a center pivot; and, the mechanism for adjusting the down-pressure, the invention is not limited thereto, but may comprise only one or any combination of these features depending on design preferences.

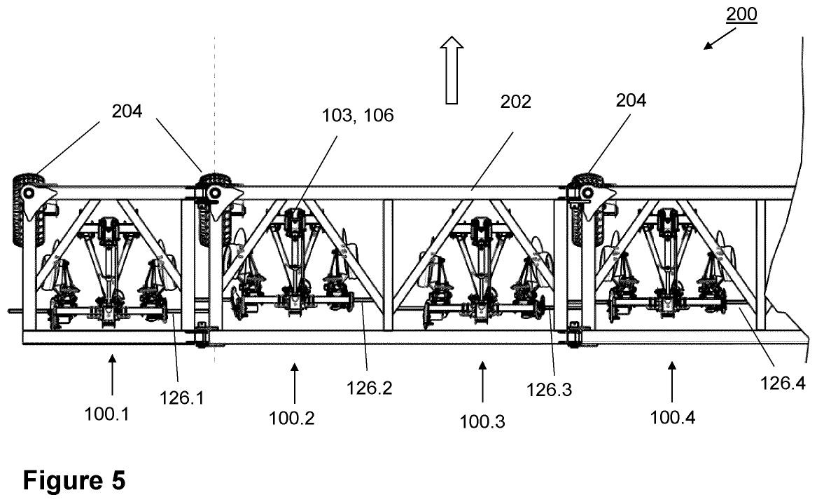

Further optionally, a multi rod rod weeder farm implement 200 comprising a plurality of rod weeders 100 may be provided. For example, the mounting structure 103, 106 of each rod weeder 100 is mounted to farm implement frame structure 202 of the farm implement 200, as illustrated in FIG. 5, such that the rod weeders 100.1, 100.2, 100.3, 100.4, . . . are placed successively in a direction perpendicular to the forward moving direction (indicated by the block arrow). The farm implement frame structure 202 is supported by wheels 204 and adapted for being connected to a tractor for pulling the same as well as for providing hydraulic power thereto. For example, hydraulic power is provided to the hydraulic cylinder 110 of each of the rod weeders 100.1, 100.2, 100.3, 100.4, . . . via hydraulic lines mounted to the farm implement frame structure 202 and connected via a hydraulic coupler to the hydraulic system of the tractor. Provision of power for moving the rod weeders 100.1, 100.2, 100.3, 100.4, . . . into the operating or field position and for moving the rod weeders 100.1, 100.2, 100.3, 100.4, . . . into the raised position is controlled by the operator of the tractor placed in the cabin thereof.

The present invention has been described herein with regard to preferred embodiments. However, it will be obvious to persons skilled in the art that a number of variations and modifications can be made without departing from the scope of the invention as described herein.

I claim:

1. A rod weeder having quick-change rod functionality comprising:
a. a mounting structure adapted for being mounted to a tractor or larger farm implement;
b. a support frame pivotally movable mounted to the mounting structure at a first end thereof;
c. a connecting structure mounted to a second end of the support frame; and
d. a support beam mounted to the connecting structure;
e. a plurality of rod shanks extending downwardly from the support beam;
f. a releaseable quick-change rod assembly mounted to the rod shanks, said releasable quick-change rod assembly comprising rod shoes corresponding to each rod shank permitting for the releasable attachment of each rod shoe to a corresponding rod shank, and a rod extending and engaged rotatably through the rod shoes and connected to a drive means for axial rotation of the rod in operation of the rod weeder;
wherein the unitary quick-change rod assembly can be mounted to or removed from the rod shanks absent use of tools.

2. The rod weeder of claim 1 further comprising a hydraulic cylinder for moving the rod weeder between a raised position and an operating position and for providing down-pressure during operation.

3. The rod weeder of claim 1 wherein the drive means comprises a rotary power source and a rotational translation element rotationally engaging the power source and the rod.

4. The rod weeder of claim 3 wherein the rotational translation element comprises a chain, a V-belt or a toothed belt.

5. The rod weeder of claim 4 wherein the rotational translation element comprises a part of the quick-change rod assembly.

6. The rod weeder of claim 4 wherein the drive means is adapted to enable installation and removal of the rotational translation element without breaking the same.

7. The rod weeder of claim 6 wherein the rod shoes and a bottom portion of the rod shanks are adapted for securing each of the rod shoes to the respective rod shank via a removable securing pin.

8. The rod weeder of claim 7 wherein each rod shoe comprises two securing elements and each bottom portion of the rod shanks comprises two respective interacting elements such that the rod shoe is secured to the rod shank in a three-point manner in concert with the securing pin.

9. The rod weeder of claim 4 wherein the drive means comprises a spring loaded or mechanical toggle lock wheel movable between an operating position and a replacement position for tensioning the rotational translation element, wherein moving the spring loaded or mechanical toggle lock wheel into the replacement position will enable the removal and replacement of the rotational translation element.

10. The rod weeder of claim 9 wherein the drive means comprises a holding element for holding the spring loaded wheel in the replacement position.

11. The rod weeder of claim 1 further comprising a plurality of gauge wheels for the purpose of establishing or maintaining the position of the rod around during operation of the rod weeder, wherein the gauge wheels are each mounted to a wheel shank extending downwardly from a first and second end portion of the support beam such that the gauge wheels are placed ahead of the rod in the forward moving direction.

12. The rod weeder of claim 11 comprising disc openers placed in proximity to the gauge wheels such that a front end thereof is placed ahead of the gauge wheels in the forward moving direction.

13. The rod weeder of claim 1 comprising a down-pressure adjusting mechanism having the hydraulic cylinder mounted thereto for enabling selection of different down-pressures exerted onto the rod.

14. A rod weeder comprising:
a. a mounting structure adapted for being mounted to a tractor or larger farm implement;
b. a support frame pivotally movable mounted to the mounting structure at a first end thereof;
c. a connecting structure mounted to a second end of the support frame;
d. a support beam mounted to the connecting structure, the support beam having a rod and drive means mounted thereto;
e. gauge wheels mounted to respective wheel shanks extending downwardly from a first and second end portion of the support beam such that the gauge wheels are placed ahead of the rod in the forward moving direction;
f. disc openers placed in proximity to the gauge wheels such that a front end thereof is placed ahead of the gauge wheels in the forward moving direction; and
g. a hydraulic cylinder for moving the rod weeder between a raised position and an operating position and for providing down-pressure during operation.

15. The rod weeder of claim 14 wherein each of the wheel shanks comprises three portions, a first portion mounted to the support beam, a second portion having the gauge wheel mounted thereto being pivotally movable mounted to the first portion, and a third portion having the disc opener mounted thereto being pivotally movable mounted to the second portion.
